(19) United States
(12) Patent Application Publication
(10) Pub. No.: US 2026/0230587 A1
(43) Pub. Date: Aug. 6, 2026

(54) DISPLAY DEVICE

(71) Applicant: NEC Corporation, Tokyo (JP)

(72) Inventors: Katsuhiko TAKAHASHI, Tokyo (JP); Kyota HIGA, Tokyo (JP); Yasunori BABAZAKI, Tokyo (JP); Ryuhei ANDO, Tokyo (JP)

(73) Assignee: NEC Corporation, Tokyo (JP)

(21) Appl. No.: 19/156,053

(22) PCT Filed: Feb. 22, 2023
(86) PCT No.: PCT/JP2023/006569

§ 371 Date: Aug. 13, 2025

(51) Int. Cl. H04N 7/18; G06Q 10/0631; G06V 20/40; G06V 20/52

(52) U.S. Cl. CPC H04N 7/181; G06Q 10/063114; G06V 20/40; G06V 20/52

(57) ABSTRACT

A display device that displays on a screen at least some videos of videos captured by a plurality of image pick-up devices installed at a site includes: an acquiring unit configured to acquire work status information that is information showing a work status at the site; a determining unit configured to determine a priority level in displaying the video in accordance with the work status information acquired by the acquiring unit; and a display unit configured to display on the screen the video selected based on the priority level determined by the determining unit.

### TECHNICAL FIELD

The present invention relates to a display device, a display method, and a recording medium.

### BACKGROUND ART

There is a known technique used in displaying a work status at a construction site and the like.

For example, Patent Literature 1 discloses a device that displays statuses at a plurality of sites. Moreover, Patent Literature 1 discloses determining a work state and displaying in accordance with the determination result for each site.

### CITATION LIST

### Patent Literature

Patent Literature 1: Japanese Unexamined Patent Application Publication No. JP-A 2022-098327

### SUMMARY OF INVENTION

### Technical Problem

Although there is a case where, when videos are acquired from a plurality of sites or videos are acquired at a plurality of locations even in a single site, all the videos cannot be displayed at one time, the case as described above is not assumed in the technique described in Patent Literature 1. Therefore, even if using the technique described in Patent Literature 1, it is not possible to accurately display in the case as described above. Thus, there is a problem that it may be difficult to accurately display when displaying videos acquired from a plurality of sites or the like.

Accordingly, an object of the present invention is to provide a display device, a display method and a program that can solve the abovementioned problem.

### Solution to Problem

In order to achieve the object, a display device as an aspect of the present disclosure is a display device displaying on a screen at least some videos of videos captured by a plurality of image pick-up devices installed at a site, and the display device includes: an acquiring unit configured to acquire work status information that is information showing a work status at the site; a determining unit configured to determine a priority level in displaying the video in accordance with the work status information acquired by the acquiring unit; and a display unit configured to display on the screen the video selected based on the priority level determined by the determining unit.

Further, a display method as another aspect of the present disclosure is display method by an information processing device displaying on a screen at least some videos of videos captured by a plurality of image pick-up devices installed at a site, and the display method includes: acquiring work status information that is information showing a work status at the site; determining a priority level in displaying the video in accordance with the acquired work status information; and displaying on the screen the video selected based on the determined priority level.

Further, a recording medium as an aspect of the present disclosure is a non-transitory computer-readable recording medium with a program recorded thereon, and the program includes instructions for causing an information processing device displaying on a screen at least some videos of videos captured by a plurality of image pick-up devices installed at a site, to enable processes to: acquire work status information that is information showing a work status at the site; determine a priority level in displaying the video in accordance with the acquired work status information; and display on the screen the video selected based on the determined priority level.

### Advantageous Effects of Invention

According to the configurations as described above, it is possible to solve the problem as described above.

### BRIEF DESCRIPTION OF THE DRAWINGS

FIG. 1 is a diagram showing an example of a configuration of a display system in a first example embodiment of the present disclosure.

FIG. 2 is a block diagram showing an example of a configuration of a display device.

FIG. 3 is a diagram showing an example of attention index information.

FIG. 4 is a diagram showing an example of camera information.

FIG. 5 is a diagram for describing an example of processing performed by a work status recognizing unit.

FIG. 6 is a diagram for describing an example of processing in determining a priority level.

FIG. 7 is a diagram showing an example of a display by a display unit.

FIG. 8 is a diagram showing an example of a display by the display unit.

FIG. 9 is a diagram showing an example of switching between displays.

FIG. 10 is a diagram showing an example of switching between displays.

FIG. 11 is a flowchart showing an example of operation of the display device.

FIG. 12 is a diagram showing an example of a hardware configuration of a display device in a second example embodiment of the present disclosure.

FIG. 13 is a block diagram showing an example of a configuration of the display device.

### DESCRIPTION OF EXAMPLE EMBODIMENTS

### First Example Embodiment

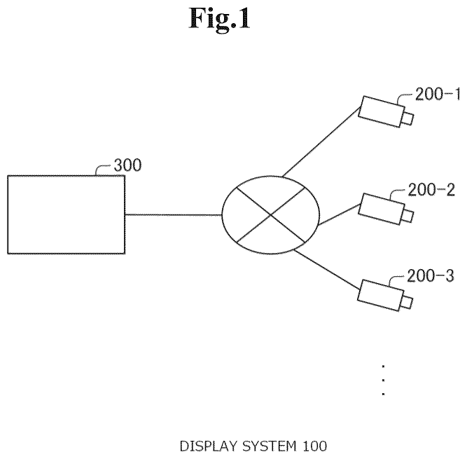

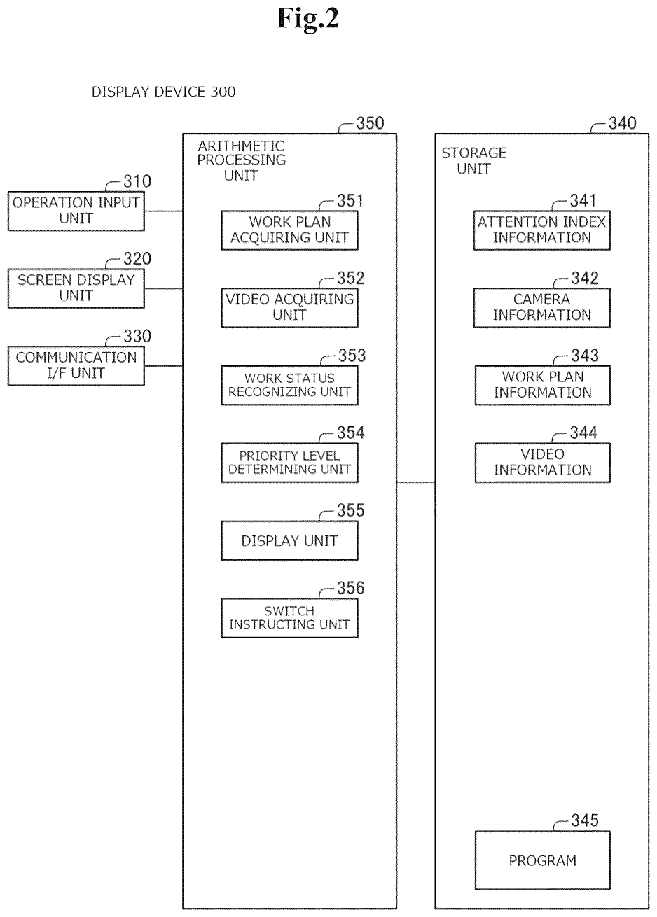

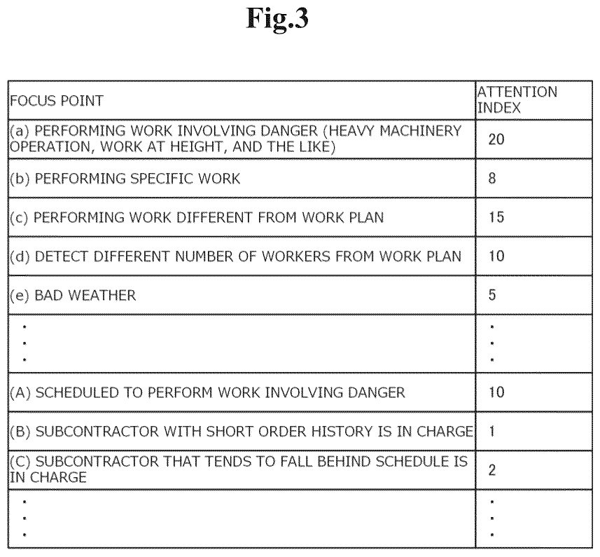

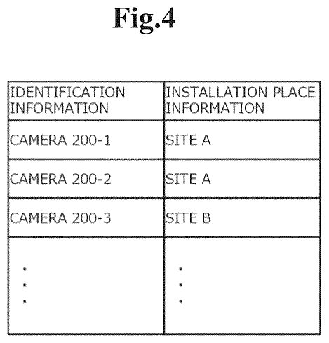

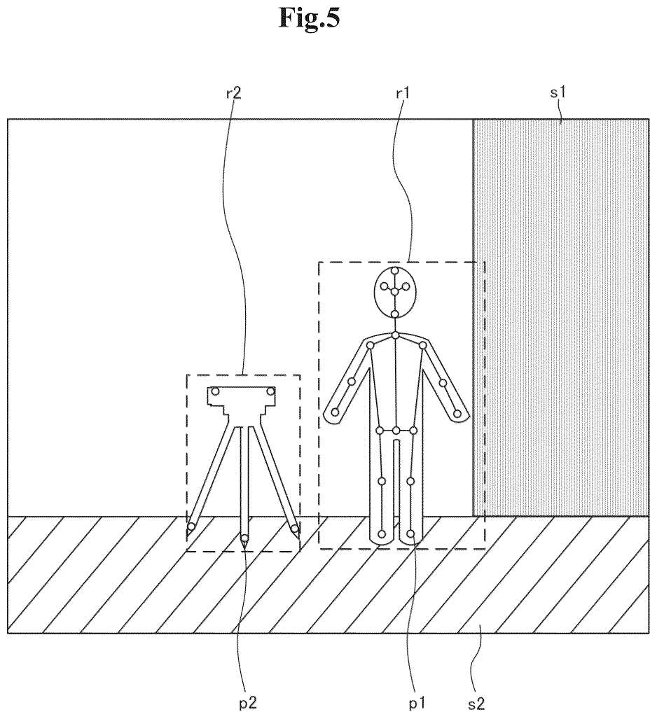

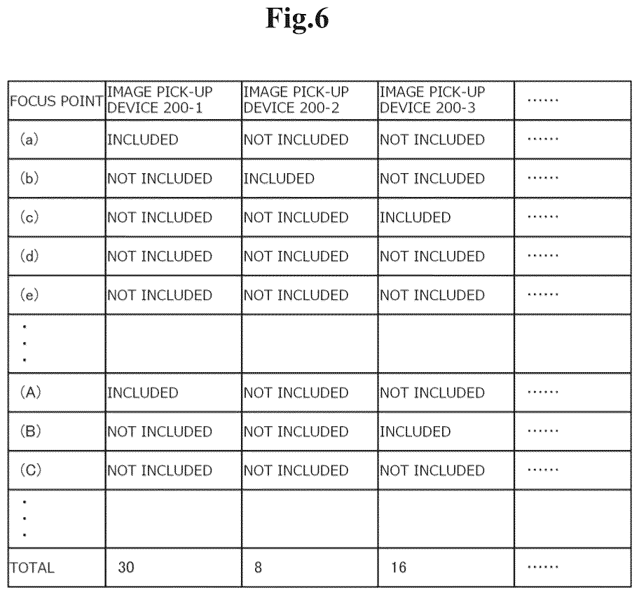

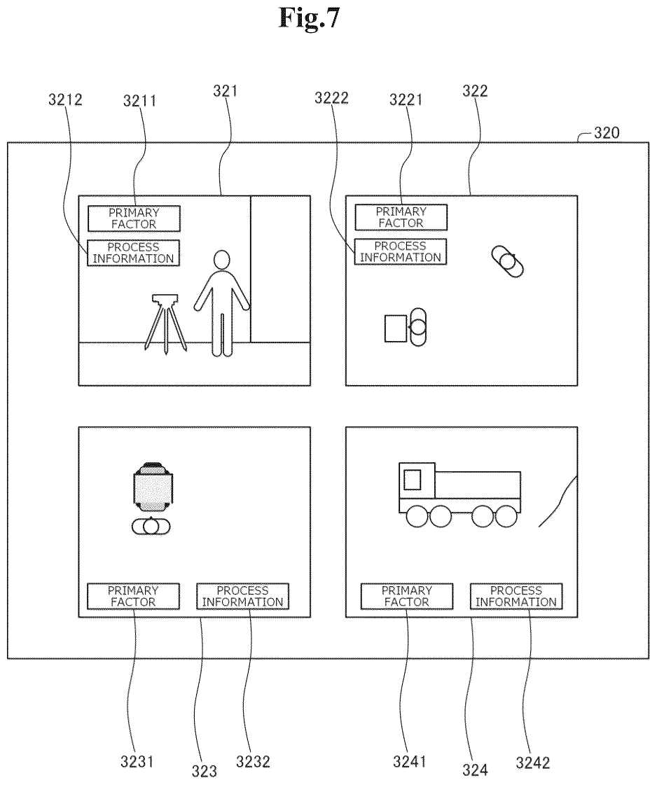

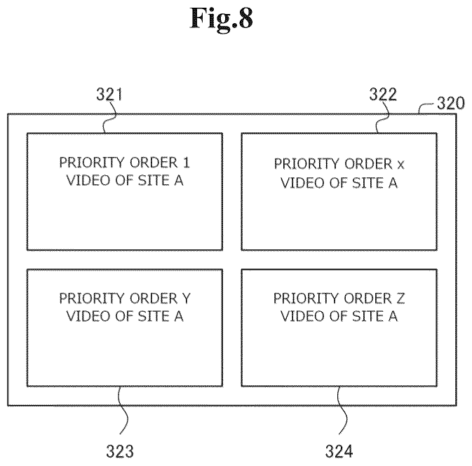

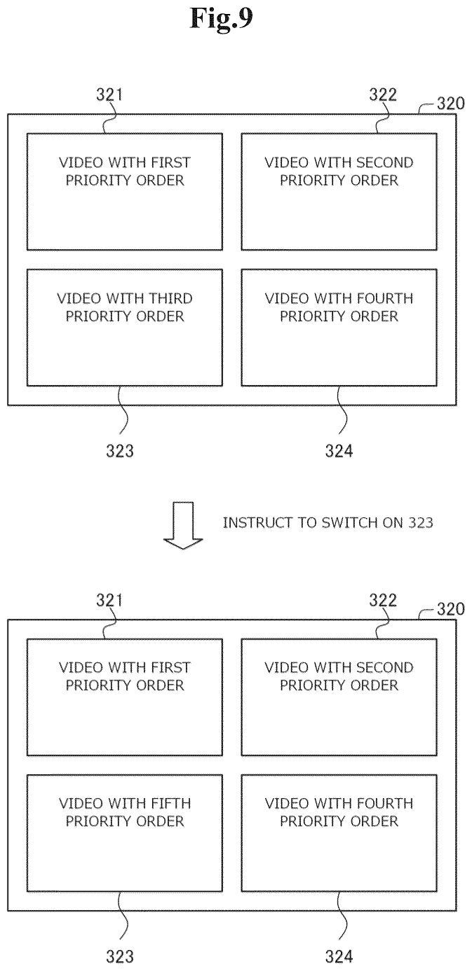

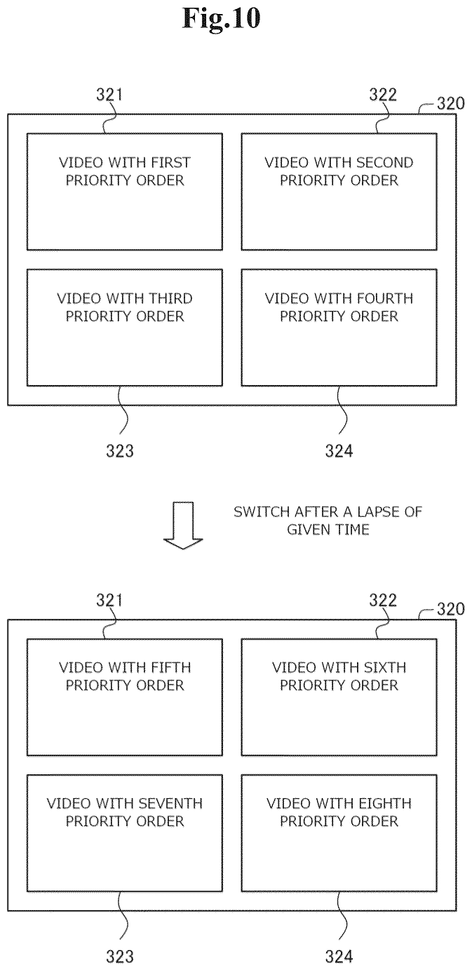

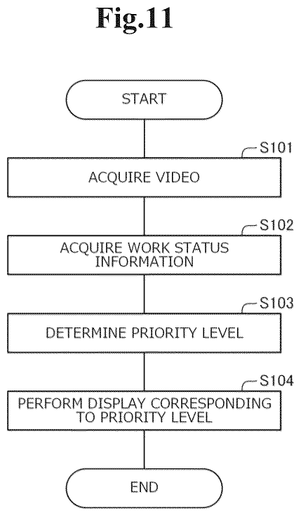

A first example embodiment of the present invention will be described with reference to FIGS. 1 to 11. FIG. 1 is a diagram showing an example of a configuration of a display system 100. FIG. 2 is a block diagram showing an example of a configuration of a display device 300. FIG. 3 is a diagram showing an example of attention index information 341. FIG. 4 is a diagram showing an example of camera information 342. FIG. 5 is a diagram for describing an example of processing performed by a work status recognizing unit 353. FIG. 6 is a diagram for describing an example of processing in determining a priority level. FIGS. 7 and 8 are diagrams showing an example of a display by a display unit 355. FIGS. 9 and 10 are diagrams showing an example of switching between displays. FIG. 11 is a flowchart showing an example of operation of the display device 300.

In the first example embodiment of the present disclosure, the display system 100 will be described that displays on a screen a video obtained by capturing a site where specified work is performed at a construction site and any other work site. For example, in the present disclosure, the display system 100 acquires videos from a plurality of image pick-up devices 200. Then, the display system 100 displays on the screen the videos acquired from at least some of the image pick-up devices 200 among the plurality of image pick-up devices 200.

Further, when performing the abovementioned display, the display system 100 can select a video to display based on a given condition, and display the selected video. For example, the display system 100 acquires work status information that is information indicating a work status at a site by using a given means to be described later. Moreover, the display system 100 determines a priority level in displaying videos based on the acquired work status information. Then, the display system 100 can select a video to display based on the determined priority.

The work status may include the content of a work being actually performed and a work environment, as well as a work schedule and the result of comparison between the work being performed and the work schedule. Moreover, the work status information may include information that enables grasp of a work status at a site, such as the content of the work, the number and attributes of workers, the work environment, the work schedule, and the comparison result. For example, the work status information can include at least part of an actual work status, such as information indicating the details of work being carried out at a site, information indicating the number of workers in the work, information indicating whether there is any unsafe behavior such as throwing materials or excessive approach to heavy machinery, information indicating the weather at a site, and information indicating progress such as completion of the work and start of the work. Moreover, the work status information may include a work schedule and peripheral information that can be acquired in advance, such as information indicating the content of work to perform and the work process, information indicating the number of workers scheduled to participate, and a degree of confidence in a vendor corresponding to an order history and a past record. Moreover, the work status information may include information corresponding to the result of comparison between an actual work status and a work schedule, such as the result of comparison between the number of workers in the work and the number of workers scheduled to participate. As an example, the display system 100 can acquire the work status information in response to inputting image data included by a video into a previously trained model or the like. Moreover, the display system 100 can acquire the work status information by referring to the work plan information 343 or the like stored in advance. The display system 100 may acquire the work status information by a method other than those illustrated above.

FIG. 1 shows an example of the configuration of the entire display system 100. Referring to FIG. 1, the display system 100 includes a plurality of image pick-up devices 200 (image pick-up device 200-1, image pick-up device 200-2, image pick-up device 200-3, . . . . Hereinafter referred to as image pick-up device 200 when not particularly distinguished), and a display device 300. As illustrated in FIG. 1, the image pick-up device 200 and the display device 300 are connected in such a manner as to be able to communicate with each other via a network and the like.

The image pick-up device 200 is installed in a specified location at a site such as a construction site and acquires a video showing a work status. The image pickup device 200 may be a general device such as a surveillance camera. For example, at least some of the plurality of image pick-up devices 200 included by the display system 100 can be installed at different sites. At least some of the plurality of image pick-up devices 200 included by the display system 100 may be installed in different locations at the same site.

Further, the image pick-up device 200 transmits the acquired video to the display device 300. For example, the image pick-up device 200 may transmit the acquired video together with identification information of the device itself to the display device 300 in such a manner that the image pick-up device 200 having acquired the video can be distinguished by the display device 300.

The display device 300 is an information processing device that displays a video acquired from the imaging device 200 on a screen. The display device 300 may be installed inside a site, or may be installed outside a site, such as a surveillance center that concentratedly monitors work at a plurality of sites. For example, the display device 300 can be configured to acquire videos from the plurality of image pick-up devices 200 and display some videos selected under a given condition from among the acquired videos.

FIG. 2 shows an example of the configuration of the display device 300. Referring to FIG. 2, the display device 300 includes, as main components, an operation input unit 310, a screen display unit 320, a communication I/F unit 330, a storage unit 340, and an arithmetic processing unit 350, for example.

FIG. 2 illustrates a case of enabling a function as the display device 300 using one information processing device. However, at least part of the function as the display device 300 may be enabled using a plurality of information processing devices, such as being enabled on the cloud, for example. Moreover, the display device 300 may not include part of the configuration illustrated above, such as not having the operation input unit 310 or the screen display unit 320, and may have a configuration other than the configuration illustrated above.

The operation input unit 310 is configured with an operation input device such as a keyboard and a mouse. The operation input unit 310 detects an operation by an operator who operates the display device 300, and outputs it to the arithmetic processing unit 350.

The screen display unit 320 is configured with a screen display device such as a liquid crystal display and an organic EL (electro-luminescence). The screen display unit 320 can display on a screen a variety of information stored in the storage unit 340 in accordance with an instruction from the arithmetic processing unit 350.

The communication I/F unit 330 is configured with a data communication circuit and the like. The communication I/F unit 330 performs data communication with an external device such as the image pick-up device 200 connected via a communication line.

The storage unit 340 is a storage device such as a hard disk and memory. The storage unit 340 stores processing information and a program 345 necessary for a variety of processing by the arithmetic processing unit 350. The program 345 is loaded and executed by the arithmetic processing unit 350 and thereby enables various processing units. The program 345 is loaded in advance from an external device or a recording medium via a data input/output function such as the communication I/F unit 330, and stored in the storage unit 340. Main information stored in the storage unit 340 includes, for example, attention index information 341, camera information 342, work plan information 343, and video information 344.

The attention index information 341 indicates an attention index, which is a value indicating display with priority, for each focus point in the work status information. The attention index information 341 is acquired in advance by any method such as inputting with the operation input unit 310 or acquiring from an external device via the communication I/F unit 330, and is stored in the storage unit 340.

FIG. 3 shows an example of the attention index information 341. Referring to FIG. 3, in the attention index information 341, a focus point and an attention index are associated. Here, a focus point indicates a point that should be noted in the work status information. For example, the focus point includes at least some of the following: a point to be noted in an actual work status that can be determined based on a video, such as the content of the work and the presence or absence of an unsafe behavior; a point to be noted in the information indicating a work schedule; and a point to be noted in the result of comparison between the actual work status and the schedule. Moreover, an attention index is a value indicating display with priority. In the case of the present disclosure, the attention index indicates that the higher the value, the higher the priority for display.

As an example, referring to FIG. 3, in the attention index information 341, a focus point “(a) Performing work involving danger” is associated with an attention index “20”. Here, work involving danger can be any determined work such as heavy machinery operation and work at height. Moreover, referring to FIG. 3, in the attention index information 341, a focus point “(b) Performing specific work” is associated with an attention index “8”. At a site such as a construction site, there may be requirements for safety measures for specific work during a designated period, such as “Ensuring greater safety for work A during the month B”. The focus point “(b) Performing specific work” illustrated above can be for any work such as work that requires particular safety measures during the designated period as mentioned above. Moreover, referring to FIG. 3, in the attention index information 341, a focus point “(c) Performing work different from in work plan” is associated with an attention index “15”. Moreover, referring to FIG. 3, in the attention index information 341, a focus point “(A) scheduled to perform work involving danger” is associated with an attention index “10”.

The attention index information 341 is not limited to the case illustrated in FIG. 3. For instance, the attention index information 341 may include focus points other than those illustrated in FIG. 3, and the value of the attention index may be other than those illustrated in FIG. 3. Moreover, the focus points and the attention indexes may be common across the sites or may vary with site. In other words, the focus points and the attention indexes may have different settings for each site. For example, the attention index information 341 may include information that associates focus points and attention indexes for each site.

Further, in the present disclosure, there is no particular limitation on a specific method for determining the attention index. For example, the attention index may be set manually, or may be determined through machine learning or the like. As an example, the attention index can be determined by performing machine learning using a video that should be displayed and a video that needs not be displayed as videos for training. For example, the attention index may be determined by learning the value of weight corresponding to each attention index using each training video in such a manner that the total of the attention indexes corresponding to the videos that should be displayed becomes larger and the total of the attention indexes corresponding to the videos that do not need to be displayed becomes smaller.

The camera information 342 includes information indicating a place where the image pick-up device 200 such as a surveillance camera is installed. For example, the camera information 342 can include information indicating a site where the image pick-up device 200 is installed, as information indicating a place where the image pick-up device 200 is installed. The camera information 342 is acquired in advance by any method such as inputting with the operation input unit 310 or acquiring from an external device via the communication I/F unit 330, and is stored in the storage unit 340.

FIG. 4 shows an example of the camera information 342. Referring to FIG. 4, in the camera information 342, identification information is associated with installation place information. Here, the identification information is information for identifying the image pick-up device 200. The identification information may be any information uniquely given to each image pick-up device 200. The installation place information includes site identification information for identifying a site where the relevant image pick-up device 200 is installed. The installation place information may include more detailed information such as a specific location in the site.

The work plan information 343 includes work plan data that shows a plan for work to be executed at a site, such as the content of work scheduled to be executed and a worker scheduled to execute the work. The work plan information 343 may include work plan data for each site. For example, the work plan data can include at least some of information showing the content and process of work to be executed, information showing the number of workers scheduled to participate, the degree of confidence in a contractor based on the order history and past record, and so forth. The work plan data may include a work schedule and data on work plan other than those illustrated above. For example, the work plan information 343 is updated in accordance with acquisition of the work plan data by a work plan acquiring unit 351, which will be described later.

The video information 344 includes a video acquired by each image pick-up device 200 included in the display system 100. For example, in the video information 344, videos are stored for each image pick-up device 200. For example, the video information 344 is updated in accordance with acquisition of a video from the image pick-up device 200 by the video acquiring unit 352.

The arithmetic processing unit 350 includes an arithmetic logic unit such as a CPU (Central Processing Unit) and a peripheral circuit thereof. The arithmetic processing unit 350 loads the program 345 from the storage unit 340 and executes it, thereby making the above hardware and the program 345 cooperate and enabling various processing units. Main processing units enabled by the arithmetic processing unit 350 include, for example, a work plan acquiring unit 351, a video acquiring unit 352, a work status recognizing unit 353, a priority level determining unit 354, a display unit 355, and a switch instructing unit 356.

The arithmetic processing unit 350 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The work plan acquiring unit 351 acquires work plan data that shows information on the content of work scheduled to be executed and a worker scheduled to perform the work. For example, the work plan acquiring unit 351 acquires work plan data corresponding to each site in accordance with acceptance of an operation via the operation input unit 310 or acquisition from an external device via the communication I/F unit 330. Moreover, the work plan acquiring unit 351 stores the acquired work plan data into the storage unit 340 as the work plan information 343.

The video acquiring unit 352 acquires a video from the image pick-up device 200. For example, the video acquiring unit 352 acquires a video from the image pick-up device 200 via the communication I/F unit 330. Moreover, the video acquiring unit 352 stores the acquired video as the video information 344 into the storage unit 340.

The work status recognizing unit 353 acquires work status information indicating a work status at a site. The work status recognizing unit 353 may acquire work status information for each video subjected to selection for display or for each image pick-up device 200 acquiring the video. For example, the work status recognizing unit 353 can acquire work status information by performing a work status recognition process on the video. Additionally, the work status recognizing unit 353 can acquire work status information by referring to the work plan information 343. In addition, the work status recognizing unit 353 can acquire new work status information that is different from the aforementioned information by comparing the result of the work status recognition process with the result of referring to the work plan information 343. For example, the work status recognizing unit 353 may acquire work status information by using at least some of the methods illustrated above.

For example, the work status recognizing unit 353 acquires work status information by performing a work status recognition process based on a video. As an example, the work status recognizing unit 353 can acquire work status information in accordance with input of image data included in a video into a previously trained model or the like. The work status recognizing unit 353 may acquire the work status information from the video by any means other than that illustrated above. For example, as a result of the work status recognition process based on the video, the work status recognizing unit 353 can acquire work status information that includes at least part of the actual work status, such as information indicating the content of work being performed at the site, information indicating the number of workers, information indicating the presence or absence of unsafe behaviors such as throwing materials and excessive approach to heavy machinery, information indicating the weather conditions at the site, and information indicating the progress of the work.

Specifically, for example, the work status recognizing unit 353 detects a person, an object and so forth based on image data included in a video by using any trained detector or the like. Moreover, the work status recognizing unit 353 not only detects a person, an object and so forth but also extracts feature information indicating the features of the person and object. For example, the work status recognizing unit 353 extracts at least some of the following as the feature information; rectangle information indicating a rectangle surrounding the detected person or object, posture information indicating the skeleton and posture of the person, shape information indicating the edge of the object, and environmental information indicating weather around the detected person or object and other surrounding environments. The work status recognizing unit 353 may perform the extraction of the feature information by using one or a plurality of trained feature value extractor or the like. Moreover, the work status recognizing unit 353 may be configured to acquire the feature information based on a plurality of image data included in a video by using any tracking function. In this case, the work status recognizing unit 353 may extract, as the feature information, for example, behavior information indicating the behavior of the person corresponding to time-series rectangle information or posture information.

FIG. 5 shows an example of the extraction by the work status recognizing unit 353. For example, referring to FIG. 5, the work status recognizing unit 353 extracts rectangle information r1 and rectangle information r2 as a result of the extraction process. Moreover, as a result of the extraction process, the work status recognizing unit 353 can extract posture information p1 and posture information p2, and can extract environmental information s1 indicating a building, environmental information s2 indicating the ground, and the like.

Further, the work status recognizing unit 353 aggregates and integrates the extracted feature information for each detected person and object. Consequently, the work status recognizing unit 353 generates integrated information for each detected person and object. Then, the work status recognizing unit 353 can acquire work status information indicating the content of work being performed by the person, based on the generated integrated information. The work status recognizing unit 353 may perform the above integration by any means, for example, acquiring integrated information that is an output from an output layer in accordance with inputting the feature information into a trained neural network having a transformation layer and an integration layer. Moreover, the work status recognizing unit 353 may acquire the work status information by any means such as recognizing the content of work in accordance with inputting the above integrated information into a trained work recognizer.

For example, the work status recognizing unit 353 can perform acquisition of work status information based on a video by executing the work status recognition process as described above. The work status recognizing unit 353 may perform acquisition of work status information based on a video by a method other than that illustrated.

Further, the work status recognizing unit 353 can acquire work status information by referring to the work plan information 343. For example, the work status recognizing unit 353 refers to the camera information 342 to specify a video or a site corresponding to the image pick-up device 200 having acquired the video. After that, the work status recognizing unit 353 can acquire work plan data corresponding to the specified site as work status information by referring to the work plan information 343.

Further, the work status recognizing unit 353 may acquire work status information by comparing the result of acquiring work status information based on a video with the result of referring to the work plan information 343. For example, the work status recognizing unit 353 can acquire work status information indicating whether or not different work from the work plan is being performed and whether or not the different number of workers from the work plan is detected by performing the above comparison.

The priority level determining unit 354 determines priority levels in displaying videos in accordance with each video acquired by the work status recognizing unit 353 or work status information corresponding to each image pick-up device 200. For example, by referring to the attention index information 341, the priority level determining unit 354 identifies an attention index corresponding to a focus point included in each work status information. Then, the priority level determining unit 354 determines a priority level in accordance with the identified result. For example, the priority level determining unit 354 can determine a priority level in accordance with calculating the total value of the attention indexes for each video.

FIG. 6 shows an example of processing by the priority level determining unit 354. Referring to FIG. 6, for example, the priority level determining unit 354 checks whether the focus point included in the attention index information 341 is included for each work status information acquired by the work status recognizing unit 353. Moreover, the priority level determining unit 354 identifies the attention index associated with the focus point included in the work status information and sums the identified values for each video (image pick-up device 200). For example, in the case illustrated in FIG. 6, the work status information corresponding to the video acquired by the image pick-up device 200-1 includes the focus points “(a) Performing work involving danger” and “(A) Scheduled to perform work involving danger”. Therefore, the priority level determining unit 354 figures out 20+10=30 as the total value of focus points corresponding to the video acquired by the image pick-up device 200-1. Moreover, in the case illustrated in FIG. 6, the work status information corresponding to the video acquired by the image pick-up device 200-2 includes the focus point “(b) Performing specific work”. Therefore, the priority level determining unit 354 figures out 8 as the total value of focus points corresponding to the video acquired by the image pick-up device 200-2. In this manner, the priority level determining unit 354 calculates a value corresponding to a focus point included in the work status information for each video or for each image pick-up device 200 acquiring the video.

For example, the priority level determining unit 354 determines the total value calculated above as a value indicating a priority level. Here, the determined priority level is a value that a priority order is higher as the value is larger. In the case illustrated in FIG. 6, for example, the total value corresponding to the video acquired by the image pick-up device 200-1 is larger than the total value corresponding to the video acquired by the image pick-up device 200-2. Therefore, the priority order for displaying the video acquired by the image pick-up device 200-1 is higher than the priority order for displaying the video acquired by the image pick-up device 200-2. As a result, the display unit 355, which will be described later, displays the video acquired by the image pick-up device 200-1 in preference to the video acquired by the image pick-up device 200-2.

The display unit 355 displays a video based on priority determined by the priority level determining unit 354. For example, the display unit 355 displays videos on the screen display unit 320 in order from a video determined to be of high priority based on the priority.

FIG. 7 shows an example of display by the display unit 355. For example, in the case illustrated in FIG. 7, the display unit 355 displays a video in each of four regions, namely, a region 321, a region 322, a region 323 and a region 324 on the screen display unit 320. As an example, the display unit 355 can display the top four videos in order from the video with the highest priority order in the region 321, the region 322, the region 323, and the region 324. The number of the regions where the display unit 355 can display is not limited to four, and may be set to any number. The display unit 355 may select videos according to the number of regions that can be displayed, and display the selected videos.

Further, as illustrated in FIG. 7, the display unit 355 can display at least one of primary factor information, process information and the like together with the videos when displaying the videos. Here, the primary factor information is information indicating a focus point used when determining the priority level. For example, the primary factor information may indicate a focus point related to an attention index of the highest value of attention indexes used when determining the priority level. Moreover, the process information is information indicating a work process that can be determined based on the content of work included in the work status information. For example, a table in which the content of one or a plurality of works and a work process are associated is stored in the storage unit 340 or the like. The display unit 355 may specify a work process by checking the above table and display the specified work process as the process information. The display unit 355 may display the content of work included in the work status information as the process information. For example, in the case illustrated in FIG. 7, a primary factor information region 3211 for displaying the primary factor information and a process information region 3212 for displaying the process information are displayed in the region 321, and a primary factor information region 3221 and a process information region 3222 are displayed in the region 322. Likewise, a primary factor information region 3231 and a process information region 3232 are displayed in the region 323, and a primary factor information region 3241 and a process information region 3242 are displayed in the region 324. As illustrated in FIG. 7, the positions of the primary factor information region and the process information region are not fixed, and can be movable in any manner.

Further, the display unit 355 can switch a video displayed in each region in accordance with an instruction from the switch instructing unit 356, which will be described later. The switch of a displayed video by the display unit 355 may also be performed in accordance with the priority level determined by the priority level determining unit 354. For example, the display unit 355 can, in accordance with an instruction from the switch instructing unit 356, switch a video being displayed in a switch target region to a video having not been displayed with a higher priority secondary to the already displayed video.

The display unit 355 may be configured to perform the display for each site with reference to the camera information 342. For example, the display unit 355 can display the top four videos in order from a video with the highest priority order among videos obtained by capturing a site corresponding to the video with the highest priority order, in the region 321, the region 322, the region 323, and the region 324. For example, in the case illustrated in FIG. 8, a video with the highest priority order is a video obtained by capturing a site A. Therefore, the display unit 355 displays the top four videos in order from a video with the high priority order among videos obtained by capturing the site A, in the region 321, the region 322, the region 323, and the region 324. Thus, the display unit 355 may be configured to display videos for each site.

Further, the display unit 355 may be configured to select whether or not to perform the display for each site described above. Whether or not to perform the display for each site may be selectable in response to an operation via the operation input unit 310, and may be selectable based on the primary factor information and work status information described above. For example, the display unit 355 may determine to perform the display for each site when it can be determined that the situation is such that a wide range is to be checked, based on the primary factor information and work status information corresponding to a video with the highest priority order. Whether or not to check a wide range may be determined in accordance with information included in the work status information, such as whether or not the content of work or the work schedule satisfies a predetermined condition.

Further, for example, when switching a video to display in each region in accordance with an instruction from the switch instructing unit 356, the display unit 355 may select a video to display based on the priority level from among all the videos included in the video information 344, or may select a video to display from among videos satisfying a predetermined condition of the videos included in the video information 344. For example, the display unit 355 may be configured to select a video to display from among videos with the total value of attention indexes calculated by the priority level determining unit 354 being equal to or more than a predetermined value.

The switch instructing unit 356 instructs the display unit 355 to switch a video to display.

For example, the switch instructing unit 356 acquires a switch instruction in accordance with acceptance of an operation via the operation input unit 310 or acquisition from an external device via the communication I/F unit 330. Then, the switch instructing unit 356 instructs the display unit 355 to switch a video to display in accordance with the acquired switch instruction. The above switch instruction may include information indicating a region (or a video) to switch. The switch instruction may include information designating the priority level or priority order of a video to switch, a site, and the like.

For example, in the case illustrated in FIG. 9, the switch instructing unit 356 acquires a switch instruction for a video being displayed in the region 323. Then, the switch instructing unit 356 instructs the display unit 355 to switch the video being displayed in the region 323. In accordance with this, the display unit 355 switches the video being displayed in the region 323 to a video having not been displayed with a high priority next to the already displayed videos.

Further, the switch instructing unit 356 can instruct the display unit 355 to switch a video to display in accordance with a given condition such as a given interval determined in advance. In this case, the switch instructing unit 356 may instruct to switch videos being displayed in all the regions, or may instruct to switch videos being displayed in some regions. For example, FIG. 10 shows an example of a case where the switch instructing unit 356 instructs the display unit 355 to switch at given intervals. The given interval may be determined by any method. The switch instructing unit 356 may be configured to instruct to switch at regular intervals regardless of a condition, and may be configured to instruct to switch when a video satisfying any condition, such as a video that the total value of the attention indexes is equal to or more than a given value, is included in videos having not been displayed.

The above is an example of the configuration of the display device 300. Subsequently, an example of the operation of the display device 300 will be described with reference to FIG. 11.

FIG. 11 is a flowchart showing an example of the operation of the display device 600. Referring to FIG. 11, the video acquiring unit 352 acquires a video from the image pick-up device 200 (step S101).

The work status recognizing unit 353 acquires work status information indicating a work status at a site (step S102). For example, the work status recognizing unit 353 may acquire work status information for each video or for each image pick-up device 200 acquiring the video, which is to be subjected to selecting the presence or absence of display and the display order. For example, the work status recognizing unit 353 can acquire work status information by performing a work status recognition process on the video. The work status recognizing unit 353 may acquire work status information by referring to the work plan information 343 or comparing the result of the work status recognition process with the result of referring to the work plan information 343.

The priority level determining unit 354 determines a priority level for displaying a video based on the work status information corresponding to each video or each image pick-up device 200 acquired by the work status recognizing unit 353 (step S103). For example, by referring to the attention index information 341, the priority level determining unit 354 identifies an attention index corresponding to a focus point included in each work status information. Then, the priority level determining unit 354 determines the priority level in accordance with the result of identification. For example, the priority level determining unit 354 can determine the priority level in accordance with calculating the total value of attention indexes for each video.

The display unit 355 displays videos based on the priority level determined by the priority level determining unit 354 (step S104). For example, the display unit 355 displays videos on the screen display unit 320 in order from a video determined to be of high priority order based on the priority level. The display unit 355 may be configured to switch a video to display in each region based on an instruction from the switch instructing unit 356.

Thus, the display device 300 includes the work status recognizing unit 353, the priority level determining unit 354, and the display unit 355. According to such a configuration, the priority level determining unit 354 can determine a priority level for displaying a video based on work status information acquired by the work status recognizing unit 353. Moreover, the display unit 355 can display a video based on the priority level determined by the priority level determining unit 354. As a result, even when acquiring videos from a plurality of sites, it is possible to perform accurate display.

Further, the work status recognizing unit 353 can acquire work status information by performing a work status recognition process on a video or referring to the work plan information 343. Thus, by acquiring work status information based on the result of the work status recognition process or the work plan data, it is possible to grasp a work status more accurately. As a result, it is possible to determine the priority level more accurately, and it is possible to perform display more accurately.

### Second Example Embodiment

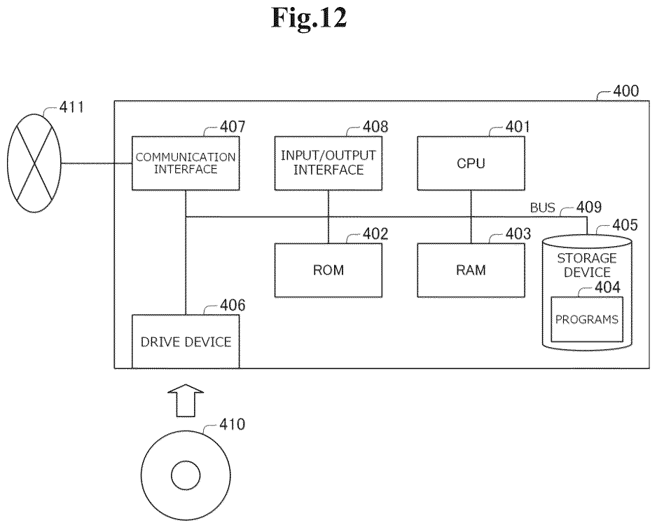

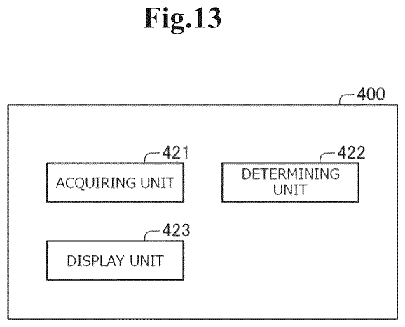

Next, a second example embodiment of the present disclosure will be described with reference to FIGS. 12 and 13. FIG. 12 is a diagram showing an example of a hardware configuration of a display device 400. FIG. 13 is a block diagram showing an example of a configuration of the display device 400.

In the second example embodiment of the present disclosure, the display device 400 will be described that displays on a screen at least some of videos captured by a plurality of image pick-up devices installed at a site. FIG. 12 shows an example of the hardware configuration of the display device 400. Referring to FIG. 12, the display device 400 includes, as an example, the following hardware configuration including:
a CPU (Central Processing Unit) 401 (arithmetic logic unit);
a ROM (Read Only Memory) 402 (memory unit);
a RAM (Random Access Memory) 403 (memory unit);
programs 404 loaded into the RAM 403;
a storage device 405 storing the programs 404;
a drive device 406 that performs reading from and writing into a recording medium 410 external to an information processing device;
a communication interface 407 connected to a communication network 411 external to the information processing device;
an input/output interface 408 that performs input/output of data; and
a bus 409 connecting the components.

Further, the display device 400 can enable functions as an acquiring unit 421, a determining unit 422 and a display unit 423 shown in FIG. 13 by acquisition and execution of the programs 404 by the CPU 401. The programs 404 are, for example, stored in advance in the storage device 405 or the ROM 402, and are loaded into the RAM 403 or the like and executed by the CPU 401 as necessary. Moreover, the programs 404 may be provided to the CPU 401 via the communication network 411, or the programs may be stored in advance in the recording medium 410 and read out and provided to the CPU 401 by the drive device 406.

FIG. 12 shows an example of the hardware configuration of the display device 400. The hardware configuration of the display device 400 is not limited to the abovementioned case. For example, the display device 400 may be configured with part of the abovementioned configuration, such as not having the drive device 406. Moreover, the CPU 401 may be a GPU or the like illustrated in the first example embodiment.

The acquiring unit 421 acquires work status information that is information showing a work status at a site.

The determining unit 422 determines a priority level for displaying a video in accordance with the work status information acquired by the acquiring unit 421.

The display unit 423 displays on a screen a video selected based on the priority level determined by the determining unit 422.

Thus, the display device 400 includes the determining unit 422 and the display unit 423. According to such a configuration, the determining unit 422 can determine a priority level for displaying a video in accordance with work status information acquired by the acquiring unit 421. As a result, the display unit 423 can display on the screen a video selected based on the priority level determined by the determining unit 422. Consequently, even when acquiring videos from a plurality of sites, it is possible to perform accurate display.

The display device 400 described above can be enabled by incorporating a predetermined program into an information processing device such as the display device 400. Specifically, a program as another aspect of the present invention is a program for causing an information processing device such as the display device 400 to enable processes to acquire work status information that is information showing a work status at a site, determine a priority level for displaying a video in accordance with the acquired work status information, and display on a screen a video selected based on the determined priority level.

Further, a display method executed by the information processing device such as the display device 400 described above is a method including acquiring work status information that is information showing a work status at a site, determining a priority level for displaying a video in accordance with the acquired work status information, and displaying on a screen a video selected based on the determined priority level.

The invention of a program or a computer-readable recording medium with a program recorded or a display method having the above configuration can achieve the object of the present disclosure described above because it exerts the same actions and effects as the display device 400 described above.

### SUPPLEMENTARY NOTES

The whole or part of the above example embodiments can be described as the following supplementary notes. Below, the overview of a display device and so forth according to the present invention will be described. However, the present invention is not limited to the following configurations.

### Supplementary Note 1

A display device displaying on a screen at least some videos of videos captured by a plurality of image pick-up devices installed at a site, the display device comprising:
an acquiring unit configured to acquire work status information that is information showing a work status at the site;
a determining unit configured to determine a priority level in displaying the video in accordance with the work status information acquired by the acquiring unit; and
a display unit configured to display on the screen the video selected based on the priority level determined by the determining unit.

### Supplementary Note 2

The display device according to supplementary note 1, wherein
the determining unit is configured to determine the priority level by calculating the priority level in accordance with a focus point included in the work status information.

### Supplementary Note 3

The display device according to supplementary note 2, wherein
the determining unit is configured to calculate the priority level by, in accordance with attention index information in which an attention index that is a value indicating display with priority is associated with the focus point, calculating a total value of the attention index associated with the focus point included in the work status information.

### Supplementary Note 4

The display device according to supplementary note 3, wherein
the attention index is set for each site.

### Supplementary Note 5

The display device according to supplementary note 3 or 4, comprising
an instructing unit configured to provide an instruction to switch the video displayed by the display unit, wherein
the display unit is configured to select the video to display from among the videos with the total value of the attention index satisfying a predetermined condition, in accordance with the instruction from the instructing unit.

### Supplementary Note 6

The display device according to any one of supplementary notes 2 to 5, wherein
the display unit is configured to display primary factor information showing the focus point used in determining the priority level, together with the video.

### Supplementary Note 7

The display device according to any one of supplementary notes 1 to 6, wherein
the acquiring unit is configured to acquire the work status information based on the video.

### Supplementary Note 8

The display device according to supplementary note 7, wherein
the acquiring unit is configured to acquire the work status information showing at least some of a content of work, a number of workers, and a work environment, based on the video.

### Supplementary Note 9

The display device according to any one of supplementary notes 1 to 8, wherein
the acquiring unit is configured to refer to work plan data showing a plan for work executed at the site, and thereby acquire the work status information.

### Supplementary Note 10

The display device according to supplementary note 9, wherein
the acquiring unit is configured to refer to the work plan data, and thereby acquire the work status information showing at least some of information showing a content of work scheduled to be executed, information showing a number of workers scheduled to participate, and a degree of confidence in a contractor according to an order history or a past record.

### Supplementary Note 11

The display device according to any one of supplementary notes 1 to 10, wherein
the acquiring unit is configured to compare the work plan data acquired based on the video with the work status information acquired by referring to work plan data showing a plan for work executed at the site, and thereby newly acquire the work status information.

### Supplementary Note 12

The display device according to any one of supplementary notes 1 to 11, wherein
the display unit is configured to display on the screen the video selected based on the priority level from among a plurality of videos obtained by capturing the same site.

### Supplementary Note 13

The display device according to supplementary note 12, wherein
the display unit is configured to select the video to display from among the videos obtained by capturing the site corresponding to the video with a highest priority order of the videos to be a target for display.

### Supplementary Note 14

The display device according to supplementary note 12 or 13, wherein
the display unit is configured to determine whether to select the video to display from among the plurality of videos obtained by capturing the same site in accordance with the information included in the work status information.

### Supplementary Note 15

A display method by an information processing device displaying on a screen at least some videos of videos captured by a plurality of image pick-up devices installed at a site, the display method comprising:
acquiring work status information that is information showing a work status at the site;
determining a priority level in displaying the video in accordance with the acquired work status information; and
displaying on the screen the video selected based on the determined priority level.

### Supplementary Note 16

A non-transitory computer-readable recording medium with a program recorded thereon, the program comprising instructions for causing an information processing device displaying on a screen at least some videos of videos captured by a plurality of image pick-up devices installed at a site, to enable processes to:
acquire work status information that is information showing a work status at the site;
determine a priority level in displaying the video in accordance with the acquired work status information; and
display on the screen the video selected based on the determined priority level.

The program described in the above example embodiments and supplementary notes is stored in a storage device, or the program is recorded on a computer-readable recording medium. For example, the recording medium is a portable medium such as flexible disk, optical disk, magneto-optical disk, and semiconductor memory.

Although the present invention has been described above with reference to the above example embodiments, the present invention is not limited to the example embodiments described above. The configuration and details of the present invention can be changed in various manners that can be understood by those skilled in the art within the scope of the present invention.

### REFERENCE SIGNS LIST

100 display system
200 image pick-up device
300 display device
310 operation input unit
320 screen display unit
321 region
3211 primary factor information region
3212 process information region
322 region
3221 primary factor information region
3222 process information region
323 region
3231 primary factor information region
3232 process information region
324 region
3241 primary factor information region
3242 process information region
330 communication I/F unit
340 storage unit
341 attention index information
342 camera Information
343 work plan information
344 video information
345 program
350 arithmetic processing unit
351 work plan acquiring unit
352 video acquiring unit
353 work status recognizing unit
354 priority level determining unit
355 display unit
356 switch instructing unit
400 display device
401 CPU
402 ROM
403 RAM
404 programs
405 storage device
406 drive device
407 communication interface
408 input/output interface
409 bus
410 recording medium
411 communication network
421 acquiring unit
422 determining unit
423 display unit

What is claimed is:

1. A display device displaying on a screen at least some videos of videos captured by a plurality of image pick-up devices installed at a site, the display device comprising:
at least one memory storing processing instructions; and
at least one processor configured to execute the processing instructions, wherein the processor is configured to execute the processing instructions to:
acquire work status information that is information showing a work status at the site;
determine a priority level in displaying the video in accordance with the acquired work status information; and
display on the screen the video selected based on the determined priority level.

2. The display device according to claim 1, wherein the processor is configured to execute the processing instructions to
determine the priority level by calculating the priority level in accordance with a focus point included in the work status information.

3. The display device according to claim 2, wherein the processor is configured to execute the processing instructions to
calculate the priority level by, in accordance with attention index information in which an attention index that is a value indicating display with priority is associated with the focus point, calculating a total value of the attention index associated with the focus point included in the work status information.

4. The display device according to claim 3, wherein
the attention index is set for each site.

5. The display device according to claim 3, wherein the processor is configured to execute the processing instructions to:
provide an instruction to switch the displayed video; and
select the video to display from among the videos with the total value of the attention index satisfying a predetermined condition, in accordance with the instruction.

6. The display device according to claim 2, wherein the processor is configured to execute the processing instructions to
display primary factor information showing the focus point used in determining the priority level, together with the video.

7. The display device according to claim 1, wherein the processor is configured to execute the processing instructions to
acquire the work status information based on the video.

8. The display device according to claim 7, wherein the processor is configured to execute the processing instructions to
acquire the work status information showing at least some of a content of work, a number of workers, and a work environment, based on the video.

9. The display device according to claim 1, wherein the processor is configured to execute the processing instructions to
refer to work plan data showing a plan for work executed at the site, and thereby acquire the work status information.

10. The display device according to claim 9, wherein the processor is configured to execute the processing instructions to
refer to the work plan data, and thereby acquire the work status information showing at least some of information showing a content of work scheduled to be executed, information showing a number of workers scheduled to participate, and a degree of confidence in a contractor according to an order history or a past record.

11. The display device according to claim 1, wherein the processor is configured to execute the processing instructions to
compare the work plan data acquired based on the video with the work status information acquired by referring to work plan data showing a plan for work executed at the site, and thereby newly acquire the work status information.

12. The display device according to claim 1, wherein the processor is configured to execute the processing instructions to
display on the screen the video selected based on the priority level from among a plurality of videos obtained by capturing the same site.

13. The display device according to claim 12, wherein the processor is configured to execute the processing instructions to
select the video to display from among the videos obtained by capturing the site corresponding to the video with a highest priority order of the videos to be a target for display.

14. The display device according to claim 12, wherein the processor is configured to execute the processing instructions to
determine whether to select the video to display from among the plurality of videos obtained by capturing the same site in accordance with the information included in the work status information.

15. A display method by an information processing device displaying on a screen at least some videos of videos captured by a plurality of image pick-up devices installed at a site, the display method comprising:
acquiring work status information that is information showing a work status at the site;
determining a priority level in displaying the video in accordance with the acquired work status information; and
displaying on the screen the video selected based on the determined priority level.

16. A non-transitory computer-readable recording medium with a program recorded thereon, the program comprising instructions for causing an information processing device displaying on a screen at least some videos of videos captured by a plurality of image pick-up devices installed at a site, to enable processes to:
acquire work status information that is information showing a work status at the site;
determine a priority level in displaying the video in accordance with the acquired work status information; and
display on the screen the video selected based on the determined priority level.
